(19) United States
(12) Patent Application Publication
(10) Pub. No.: US 2021/0326386 A1
(43) Pub. Date: Oct. 21, 2021

(54) INFORMATION PROCESSING SYSTEM, INFORMATION PROCESSING DEVICE, AND NON-TRANSITORY COMPUTER-READABLE STORAGE MEDIUM FOR STORING PROGRAM

(71) Applicant: FUJITSU LIMITED, Kawasaki-shi (JP)

(72) Inventor: HIROKI OHTSUJI, Yokohama (JP)

(73) Assignee: FUJITSU LIMITED, Kawasaki-shi (JP)

(21) Appl. No.: 17/190,486

(22) Filed: Mar. 3, 2021

(30) Foreign Application Priority Data
Apr. 17, 2020 (JP) 2020-073930

(51) Int. Cl. G06F 16/901; G06F 16/9035; G06F 17/18

(52) U.S. Cl. CPC G06F 16/9017; G06F 17/18; G06F 16/9027; G06F 16/9035

(57) ABSTRACT

A system configured to manage information in a plurality of directories in a distributed manner, wherein the system is configured to perform processing by a first computers that is one of a plurality of computers, the processing including: obtaining, in response to an occurrence of a communication targeting a directory managed by a respective communication destination computer, a weight corresponding to the directory targeted by the communication, wherein each directory managed by the plurality of computers is associated with a respective weight determined based on a tree structure of the plurality of directories; determining, based on the obtained weight, a priority of a connection used for the communication, wherein each connection established with the respective communication destination computer is associated with a respective priority; and selecting, based on the determined priority, a connection from among each connection established with the plurality of computers to terminate the selected connection.

### CROSS-REFERENCE TO RELATED APPLICATION

This application is based upon and claims the benefit of priority of the prior Japanese Patent Application No. 2020-73930, filed on Apr. 17, 2020, the entire contents of which are incorporated herein by reference.

### FIELD

The embodiments discussed herein are related to an information processing system, an information processing device, and a non-transitory computer-readable storage medium storing a program.

### BACKGROUND

In the field of information processing, to efficiently handle a large number of directories and files, data management by a distributed file system is sometimes performed. In a distributed file system, a file is divided into a data body and additional information for the data body, which are then managed in a distributed manner by different information processing devices. The additional information for the data body may be referred to as, for example, meta information or metadata.

For example, a distributed file system has been proposed in which not just data of files but also metadata such as detailed information of files/directories and directory entries are placed in a distributed manner in a plurality of servers for each file and directory. The proposed distributed file system allows not just read/write processing from/to files but also metadata access processing such as file open processing to be performed in a distributed manner by a plurality of servers.

Note that an information processing device has been proposed in which, in a case where the rate of increase in connections with other information processing devices exceeds a first threshold value and the number of connections that have been maintained exceeds a second threshold value, the connections are terminated preferentially from the one through which the last communication has been performed the earliest.

Examples of the related art include Japanese Laid-open Patent Publication No. 2017-123040 and Japanese Laid-open Patent Publication No. 2019-8417.

### SUMMARY

According to an aspect of the embodiments, provided is an information processing system includes a plurality of information processing devices configured to manage information in a plurality of directories in a distributed manner, wherein a first information processing device that is any one of the plurality of information processing devices is configured to perform processing. In an example, the processing includes: managing, for a respective communication destination information processing device for the first information processing, a connection established with the respective communication device, the respective communication destination information processing device being any one of the plurality of information processing devices other than the first information processing devices; obtaining, in response to an occurrence of a communication targeting a directory managed by the respective communication destination information processing device, a weight corresponding to the directory targeted by the occurred communication, wherein each directory of the plurality of directories managed by the plurality of information processing devices is associated with a respective weight determined based on a tree structure of the plurality of directories; determining, based on the obtained weight, a priority of the connection used for the occurred communication, wherein each connection established with the respective communication destination information processing device is associated with a respective priority; and selecting, on the basis of the determined priority, a connection from among each connection established with the plurality of information processing devices to terminate the selected connection.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a processing example of an information processing system according to a first embodiment;

FIG. 2 is a diagram illustrating an example of an information processing system according to a second embodiment;

FIG. 3 is a diagram illustrating a hardware example of an MDS;

FIG. 4 is a diagram illustrating an example of a directory structure and a physical server connection;

FIG. 5 is a diagram illustrating an example of a directory structure and a logical server connection;

FIG. 6 is a diagram illustrating an example of functions of an MDS;

FIG. 7 is a diagram illustrating an example of metadata;

FIG. 8 is a diagram illustrating an example of a connection management table;

FIG. 9 is a diagram illustrating an example of a weighted communication count table;

FIGS. 10A and 10B are diagrams illustrating examples of the trend of access;

FIG. 11 is a flowchart illustrating an example of connection management processing;

FIG. 12 is a flowchart illustrating an example of weighted communication count processing; and

FIG. 13 is a diagram illustrating an example of connections to be maintained.

### DESCRIPTION OF EMBODIMENTS

As described above, a plurality of information processing devices manages a plurality of directories in a distributed manner in some cases. In such a case, each information processing device communicates with another information processing device to receive information in a directory managed by the other information processing device, or transmit information in a directory managed by the information processing device to the other information processing device.

Here, a certain information processing device may establish, with another information processing device, a connection based on a predetermined communication protocol, and use the connection to make a query for information in a directory managed by the other information processing device. Using the connection allows the information processing device to communicate with the other information processing device at a speed higher than that in a connectionless communication.

Maintaining a connection consumes resources such as a central processing unit (CPU) and memory in an information processing device. On the other hand, resources available to an information processing device are limited. For this reason, there is a problem in that it is difficult to permanently maintain all established connections. For this reason, it is possible to consider, as in the proposal described above, a method in which connections are terminated preferentially from the one through which the last communication has been performed the earliest. However, with the proposed method described above, there is a possibility that a connection that is likely to be used for a relatively large number of communications in the future may be terminated.

According to one aspect, an object of the embodiments is to provide an information processing system, an information processing device, and a program that terminates an appropriate connection.

Hereinafter, the embodiments will be described with reference to the drawings.

### First Embodiment

A first embodiment will be described.

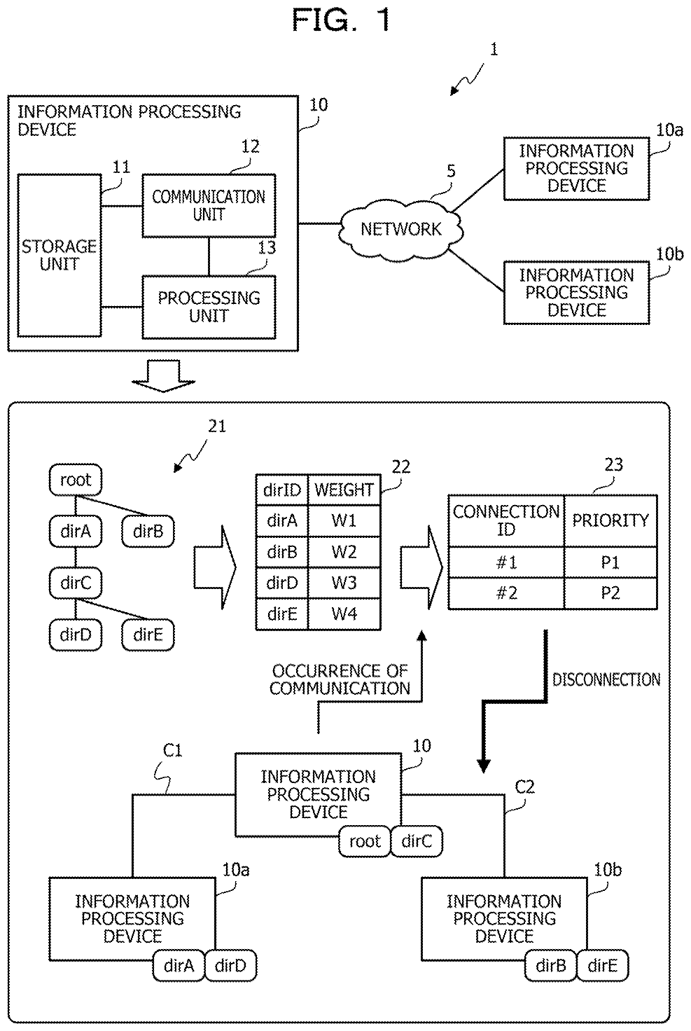

FIG. 1 is a diagram illustrating a processing example of an information processing system according to the first embodiment.

An information processing system 1 includes information processing devices 10, 10a, and 10b. The information processing devices 10, 10a, and 10b are connected to a network 5. The information processing system 1 provides, for example, a distributed file system for a client device (not illustrated in FIG. 1) connected to the network 5.

The information processing devices 10, 10a, and 10b manage information in a plurality of directories in a distributed manner. The information in the directories may include information regarding, for example, directory structures, directory names, directory creation dates and times, update dates and times, and access authorities. The information in the directories may be information referred to as meta information, metadata, or the like.

The plurality of directories has a tree structure. The tree structure indicates a hierarchical structure of the directories. A directory tree 21 is an example of a tree structure for directories, for example, root, dirA, dirB, dirC, dirD, and dirE. Here, the directory root is a root directory. The directories dirA and dirB are directly under the directory root. The directory dirC is directly under the directory dirA. The directories dirD and dirE are directly under the directory dirC.

In the example depicted in FIG. 1, The information processing devices 10, 10a, and 10b manage information (for example, meta information) in the directories root, dirA, dirB, dirC, dirD, and dirE in a distributed manner. The information processing device 10 retains information in the directories root and dirC. The information processing device 10a retains information in the directories dirA and dirD. The information processing device 10b retains information in the directories dirB and dirE.

In the example of the directory tree 21, the information processing device 10 communicates with the information processing device 10a to acquire the information in the directories dirA and dirD. Furthermore, the information processing device 10 communicates with the information processing device 10b to acquire the information in the directories dirB and dirE. Thus, each of the information processing devices 10a and 10b is an example of a communication destination information processing device that communicates with the information processing device 10.

Note that files may be placed directly under each of the directories root, dirA, dirB, dirC, dirD, and dirE. The information processing devices 10, 10a, and 10b may, for example, manage, in a distributed manner, meta information in a plurality of files. The meta information in the files may include directory structures, file names, creation dates and times of the files, access authorities, and address information of information processing devices (not illustrated in FIG. 1) in which data bodies of the files are placed.

For example, the information processing devices 10, 10a, and 10b may receive a request to access a directory or a file from a client device connected to the network 5. In response to the access request, the information processing devices 10, 10a, and 10b may return, to the client device, contents of the directory or a storage destination address of data body of the file. For example, allocation of directories and files to be managed by the information processing devices 10, 10a, and 10b is determined on the basis of hashes of full paths of the directories and files. In this case, by using the hash of the full path of the directory or file to be accessed, the client device determines an information processing device to which an access request is to be transmitted.

The information processing device 10 includes a storage unit 11, a communication unit 12, and a processing unit 13.

The storage unit 11 may be a volatile storage device such as a random access memory (RAM), or may be a non-volatile storage device such as a hard disk drive (HDD) or a flash memory.

The communication unit 12 is a communication interface connected to the network 5 and communicates with the information processing devices 10a and 10b. For example, the communication unit 12 is connected to a switch belonging to the network 5 by a cable. A standard such as infiniband is used for the communication interface in the communication unit 12 and the network 5.

The processing unit 13 may include a central processing unit (CPU), a digital signal processor (DSP), an application specific integrated circuit (ASIC), or a field programmable gate array (FPGA). The processing unit 13 may be a processor that executes a program. The “processor” here may include a set of a plurality of processors (multiprocessor).

The communication unit 12 communicates with a communication destination information processing device by using a connection established for each communication destination information processing device. The connection is established on the basis of a protocol according to the standard of the communication interface. For example, in a case where infiniband is used as the standard of the communication interface, the connection is established on the basis of a remote direct memory access (RDMA) protocol However, the connection may be established on the basis of another communication protocol.

For example, a connection C1 is a connection established by the information processing device 10 for the information processing device 10a. A connection C2 is a connection established by the information processing device 10 for the information processing device 10b. Information for managing the connections is stored in the storage unit 11. Note that the communication unit 12 may perform connectionless-type communication without establishing a connection with a communication destination information processing device. However, connectionless-type communication is slower than connection-oriented communication. This is because, in a case of connection-oriented communication, resources for communication in the connection are secured in advance, whereas in a case of connectionless-type communication, resources for communication with the other information processing device are not secured in advance. For this reason, in connectionless-type communication, each information processing device performs message-based communication, which causes extra processing such as data copying in the same RAM, and thus connectionless-type communication is slower than connection-oriented communication. However, connection-oriented communication consumes resources to maintain connections.

The processing unit 13 assigns a weight to each directory managed by a communication destination information processing device on the basis of the tree structure indicated by the directory tree 21. For example, on the basis of a name of a subdirectory included in information in a directory managed by the processing unit 13, the processing unit 13 recognizes the full path of the subdirectory subordinate to the directory. Furthermore, on the basis of the hash of the full path of the subdirectory, the processing unit 13 identifies the communication destination information processing device that manages the subdirectory.

For example, on the basis of the tree structure of the directory tree 21, the processing unit 13 assigns a weight to each of the directories dirA and dirD managed by the information processing device 10a and each of the directories dirB and dirE managed by the information processing device 10b. The processing unit 13 may generate weight information 22, which is a result of assigning the weights, and store the weight information 22 in the storage unit 11. For example, the weight information 22 includes “dirID (identifier)” and “Weight” items. “dirID” is where directory names are registered. “Weight” is where assigned weights are registered. The weights are represented by, for example, numerical values, and indicate that the larger the numerical value, the more important the corresponding directory or the communication for the corresponding directory. The weight information 22 indicates the following contents. The weight of the directory dirA is W1. The weight of the directory dirB is W2. The weight of the directory dirD is W3. The weight of the directory dirE is W4.

Here, the processing unit 13 performs weighting so that the higher the directory is in the directory tree 21, the larger the weight tends to be. This is because the higher the directory, the more entries (directories and files) there are subordinate to the corresponding directory, and the amount of communication for acquiring information in the corresponding directory tends to become relatively large.

For example, pieces of information in directories are distributed among the information processing devices 10, 10a, and 10b, and the directories have a tree structure. Thus, information in a higher directory or a lower directory is needed in some cases. In such a case, a query needs to be made from one information processing device to another information processing device, and the higher the directory, the more often the query tends to occur.

As a first method of weighting, it is possible to consider a method in which a total number of accesses to the entries under the corresponding directory is used as the weight of the corresponding directory. Alternatively, as a second method of weighting, it is possible to consider a method in which a total number of entries existing under the corresponding directory is used as the weight of the corresponding directory.

For example, the processing unit 13 may apply the first method in a case where variation in the number of accesses is large (in a case where an average value of distributions in the number of directory accesses for each directory level is equal to or greater than a threshold value). On the other hand, the processing unit 13 may apply the second method in a case where variation in the number of accesses to each directory for each level is small (in a case where an average value of distributions in the number of directory accesses for each directory level is smaller than the threshold value).

On the basis of an occurrence of a communication for a directory, the processing unit 13 uses the weight of the directory to determine a priority of a connection used for the communication. In the example of the information processing device 10, the connections C1 and C2 are included. Thus, the processing unit 13 determines the priority of each of the connections C1 and C2.

The processing unit 13 registers the determined priority in priority information 23. The priority information 23 is stored in the storage unit 11. The priority information 23 includes “Connection ID” and “Priority” items. The connection ID is identification information of a connection established by the information processing device 10 with a communication destination information processing device. For example, the connection ID of the connection C1 is #1. The connection ID of the connection C2 is #2. The priority is the priority of the corresponding connection. The initial value of the connection priority is 0.

The priority is represented by, for example, a numerical value. The larger the numerical value of priority, the higher the priority of maintaining the corresponding connection and the lower the priority of terminating the connection. On the other hand, the smaller the numerical value of priority, the lower the priority of maintaining the corresponding connection and the higher the priority of terminating the connection. For this reason, it may be said that the priority of the connection represents the priority of maintaining the connection. Conversely, it may be said that the priority of the connection represents the priority of terminating the connection.

For example, a case is assumed in which the processing unit 13 queries the information processing device 10a for information in the directory dirA in response to an access request (for example, a request for confirming existence of the directory dirA subordinate to the directory root, or a request for detailed information) or the like received from a client device. In this case, the query causes an occurrence of one communication for the directory dirA from the information processing device 10 to the information processing device 10a. Then, the processing unit 13 refers to the weight information 22, acquires the weight W1 of the directory dirA, and adds the weight W1 to the priority of the connection C1.

Furthermore, for example, a case is assumed in which the processing unit 13 queries the information processing device 10b for information in the directory dirE in response to an access request (for example, a request for confirming existence of the directory dirE subordinate to the directory dirC, or a request for detailed information) or the like received from a client device. In this case, the query causes an occurrence of one communication for the directory dirE from the information processing device 10 to the information processing device 10b. Then, the processing unit 13 refers to the weight information 22, acquires the weight W4 of the directory dirE, and adds the weight W4 to the priority of the connection C2.

In this way, the processing unit 13 updates the priority of each of the connections C1 and C2 in the priority information 23 each time communication for a directory managed by the information processing device 10a or 10b occurs.

The processing unit 13 terminates at least one of a plurality of connections at a predetermined timing on the basis of the priority in the priority information 23. For example, the processing unit 13 terminates either one of the connections C1 and C2 on the basis of the priority information 23. According to the priority information 23, the priority of the connection C1 is P1, and the priority of the connection C2 is P2. For example, in a case where the priority P1 of the connection C1 is higher than the priority P2 of the connection C2, for example, in a case where P1>P2 holds, the processing unit 13 selects, from the connections C1 and C2, the connection Q as a connection to be terminated, and terminates the connection C2. Terminating the connection C2 releases the resource needed to maintain the connection C2, and reduces load on the information processing device 10.

Examples of the predetermined timing described above may include a timing in which the load on the information processing device 10 exceeds an allowable upper limit or a periodic timing. The processing unit 13 may terminate the connection when the load on the information processing device 10 exceeds the allowable upper limit thereby reducing the load. Alternatively, in a case where there is a plurality of connections, the processing unit 13 may periodically terminate at least one of the connections on the basis of the priority information 23.

The number of connections to be terminated by the processing unit 13 may be a specified number, or may be determined on the basis of a relationship between “the allowable number of connections maintained” and “the priority of connectionless communication and the priority of maintained connections”. For example, the priority of connectionless communication may be determined in a similar manner to the priority of connections. This allows the processing unit 13 to establish new connections of the same number as the connections that have been terminated, for a high-priority connectionless communication path. Alternatively, in a case where a resource usage by the information processing device 10 is higher than a threshold value, the processing unit 13 may terminate connections of the number corresponding to an amount of resources, which is a difference between the resource usage and the threshold value.

According to the information processing device 10, on the basis of a tree structure including a plurality of directories, a weight of communication with a communication destination information processing device among a plurality of information processing devices is assigned for each directory managed by the communication destination information processing device. On the basis of an occurrence of a communication for a directory, the weight of the directory is used to determine the priority of the connection used for communication with the communication destination information processing device. At least one connection is terminated on the basis of the priority of each of a plurality of connections to a plurality of communication destination information processing devices.

As a result an appropriate connection may be terminated.

Here, maintaining connections consumes resources such as a CPU and a RAM in an information processing device. This is because, for example, a predetermined area in the RAM is secured for the corresponding connection, or polling by the CPU occurs for confirmation of whether there is data for the corresponding area in the RAM. On the other hand, resources available to an information processing device are limited. For this reason, it is difficult to permanently maintain all established connections.

For this reason, the information processing device 10 terminates at least one connection on the basis of the priority of the connections C1 and C2 to release the resource used for the connection. As a result, the load on the information processing device 10 is reduced.

For example, at this time, the information processing device 10 determines the priority of the connections C1 and C2 by using weights assigned one to each directory managed by a communication destination information processing device. The information processing device 10 assigns a weight to each directory on the basis of the tree structure of the directory tree 21. Thus, the priority of each connection reflects the weight of each directory based on the tree structure of the directory tree 21. For this reason, a connection used for communication for a directory of relatively higher importance may have higher priority. It may be said that a high-priority connection is a connection that is likely to be used for a relatively large number of communications.

The information processing device 10 is capable of performing, on the basis of the priority, control for terminating low-priority connections but not terminating high-priority connections. For example, the information processing device 10 is capable of terminating connections used for communication for directories of relatively lower importance. It is estimated that, in a case of a connection used for communication for a directory of low importance, terminating the connection has a smaller influence on data access performance in the information processing system 1 than in a case of a connection used for communication for a directory of high importance. Thus, the information processing device 10 is capable of terminating an appropriate connection so as to suppress deterioration in data access performance of the information processing system 1.

For example, as described above, the information processing device 10 may assign a weight to each directory so that a directory at a higher level in the tree structure tends to have a larger weight. This allows a directory at a higher level to be given a higher importance. This is because it is estimated that a directory at a higher level has more subordinate entries, and has a larger amount of communication for making queries for directory information. As a result, connections used for communication for directories at relatively lower levels tend to be terminated, and thus appropriate connections are terminated so as to suppress deterioration in data access performance in the information processing system 1.

### Second Embodiment

Next, a second embodiment will be described.

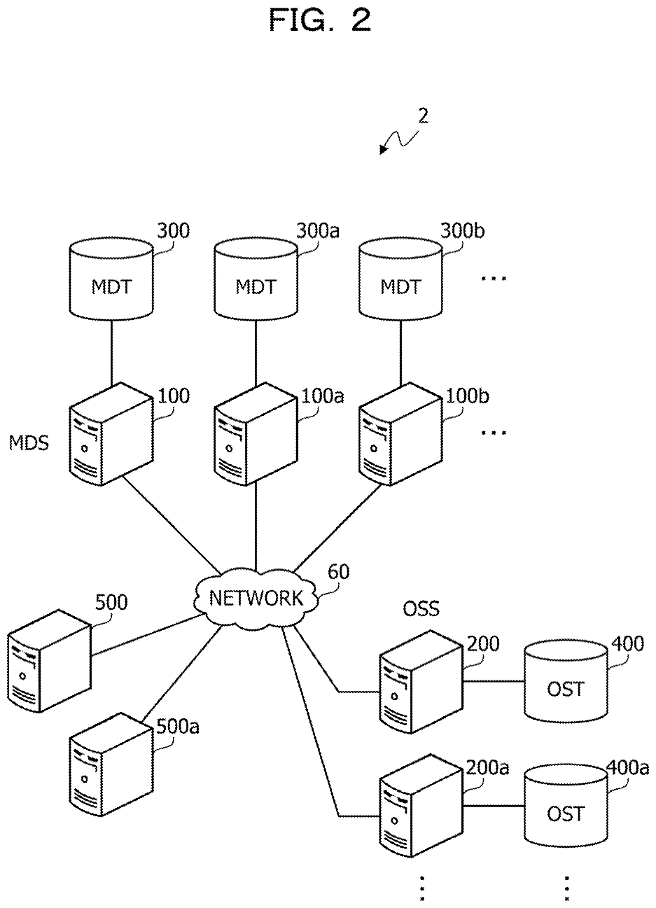

FIG. 2 is a diagram illustrating an example of an information processing system according to the second embodiment.

An information processing system 2 includes metadata servers (MDSs) 100, 100a, 100b, . . . , object storage servers (OSSs) 200, 200a, . . . , metadata targets (MDTs) 300, 300a, 300b, . . . , object storage targets (OSTs) 400, 400a, . . . , and clients 500 and 500a.

The MDSs 100, 100a, 100b, . . . , the OSSs 200, 200a, . . . , the MDTs 300, 300a, 300b, . . . , the OSTs 400, 400a, . . . , and the clients 500 and 500a are connected to a network 60. The network 60 is, for example, a fabric including an infiniband switch (not illustrated).

The MDSs 100, 100a, 100b, . . . , the OSSs 200, 200a, . . . , the MDTs 300, 300a, 300b, . . . , and the OSTs 400, 400a, . . . provide a distributed file system.

The MDSs 100, 100a, 100b, . . . are server computers that manage metadata in directories and files. The MDSs 100, 100a, 100b, . . . are connected to the MDTs 300, 300a, 300b, . . . , respectively. The MDTs 300, 300a, 300b, . . . are storage devices that store metadata. The MDTs 300, 300a, 300b, . . . are implemented by storage devices such as HDDs or solid state drives (SSDs). The MDTs 300, 300a, 300b, . . . may be incorporated in the MDSs 100, 100a, 100b, . . . , respectively. The metadata may include identification information, creation dates and times, and access authorities of files and directories, and information such storage destination addresses of data bodies of the files and storage destination addresses of data bodies of the directories.

The MDSs 100, 100a, 100b, . . . are examples of the information processing devices 10, 10a, and 10b according to the first embodiment.

The OSSs 200, 200a, . . . are server computers that manage data bodies of files and directories. The data bodies of files and directories are sometimes referred to as objects. A data body of a directory may include directory structure information that includes identification information of a directory or a file that exists directly under the directory. However, the directory structure information may be included in the metadata. The OSSs 200, 200a, . . . are connected to the OSTs 400, 400a, . . . , respectively. The OSTs 400, 400a, . . . are storage devices that store objects. The OSTs 400, 400a, . . . are implemented by storage devices such as HDDs or SSDs. The OSTs 400, 400a, . . . may be incorporated in the OSSs 200, 200a, . . . , respectively.

The clients 500 and 500a are client computers that execute an application used by a user. The application of the clients 500 and 500a executes processing using a file stored in the OSTs 400, 400a, . . . . When trying to access a file or a directory stored in the OSTs 400, 400a, . . . , the client 500 or 500a first acquires, from the MDSs 100, 100a, 100b, . . . , a storage destination address of a data body of the corresponding file or directory. At this time, the client 500 or 500a determines which MDS to send a query on the basis of a hash of a full path of the file or directory to be accessed. Each MDS is associated with a hash in advance. The hash corresponds to an identification number of the MDS. The client 500 or 500a retains in advance information indicating a correspondence relationship between a hash and an address of an MDS associated with the hash.

The storage destination address indicates an address of an OSS that manages the data body of the corresponding file or directory. The client 500 or 500a transmits an acquisition request for the data body of the corresponding file or directory to the OSSs 200, 200a, . . . on the basis of the acquired storage destination address. The client 500 or 500a acquires the data body of the file or the data body of the directory from the OSSs 200, 200a, . . . as a response to the acquisition request.

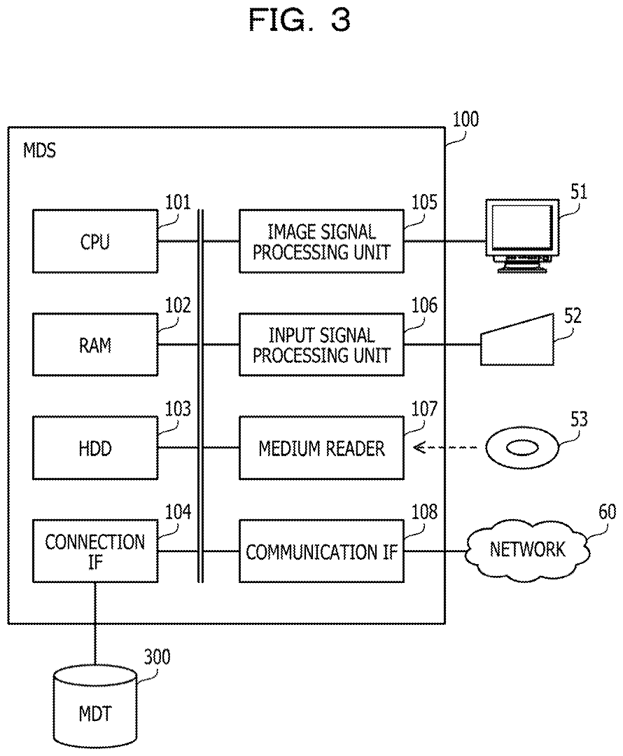

FIG. 3 is a diagram illustrating a hardware example of an MDS.

The MDS 100 includes a CPU 101, a RAM 102, an HDD 103, a connection interface (IF) 104, an image signal processing unit 105, an input signal processing unit 106, a medium reader 107, and a communication IF 108. Note that the CPU 101 is an example of the processing unit 13 according to the first embodiment. The RAM 102 or the HDD 103 is an example of the storage unit 11 according to the first embodiment. The communication IF 108 is an example of the communication unit 12 according to the first embodiment.

The CPU 101 is a processor that executes a program command. The CPU 101 loads at least a part of programs and data stored in the HDD 103 into the RAM 102 and executes the program. Note that the CPU 101 may include a plurality of processor cores. Furthermore, the MDS 100 may include a plurality of processors. The processing described below may be executed in parallel using a plurality of processors or processor cores. Furthermore, a set of a plurality of processors may be referred to as a “multiprocessor” or simply a “processor”.

The RAM 102 is a volatile semiconductor memory that temporarily stores the program executed by the CPU 101 and the data used by the CPU 101 for operations. Note that the MDS 100 may include any type of memory other than the RAM, or may include a plurality of memories.

The HDD 103 is a non-volatile storage device that stores a program of software such as an operating system (OS), middleware, and application software, and data. Note that the MDS 100 may include another type of storage device such as a flash memory or an SSD, or may include a plurality of non-volatile storage devices.

The connection IF 104 is a communication interface connected to the MDT 300. As the connection IF 104, for example, an interface such as a fiber channel, serial attached SCSI (SAS) (SCSI is an abbreviation for small computer system interface), or infiniband is used.

The image signal processing unit 105 outputs an image on a display 51 connected to the MDS 100 according to a command from the CPU 101. As the display 51, any type of display such as a cathode ray tube (CRT) display, a liquid crystal display (LCD), a plasma display, or an organic electro-luminescence (OEL) display may be used.

The input signal processing unit 106 acquires an input signal from an input device 52 connected to the MDS 100, and outputs the input signal to the CPU 101. As the input device 52, a pointing device such as a mouse, a touch panel, a touch pad, or a trackball, a keyboard, a remote controller, a button switch, or the like may be used. Furthermore, a plurality of types of input devices may be connected to the MDS 100.

The medium reader 107 is a reading device that reads a program or data recorded on a recording medium 53. As the recording medium 53, for example, a magnetic disk, an optical disk, a magneto-optical (MO) disk, a semiconductor memory, or the like may be used. The magnetic disk includes a flexible disk (FD) and an HDD. The optical disk includes a compact disc (CD) and a digital versatile disc (DVD).

The medium reader 107 copies, for example, a program or data read from the recording medium 53 to another recording medium such as the RAM 102 or the HDD 103. The read program is executed by the CPU 101, for example. Note that the recording medium 53 may be a portable recording medium, and may be used for distribution of the program and data. Furthermore, the recording medium 53 and the HDD 103 may be referred to as computer-readable recording media.

The communication IF 108 is an interface that is connected to the network 60 and communicates with another computer via the network 60. Infiniband is used as a standard for the communication IF 108. The communication IF 108 is connected to, for example, a switch belonging to the network 60 by a cable.

Note that the MDSs 100a, 100b, . . . , the OSSs 200, 200a, . . . , and the clients 500 and 500a are also implemented by hardware similar to the MDS 100.

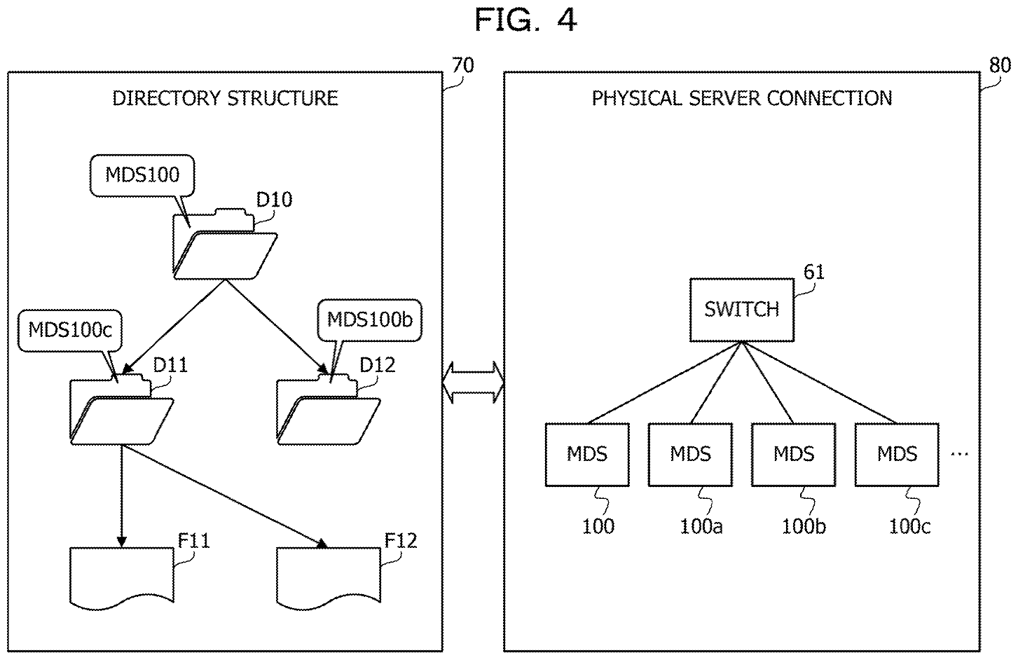

FIG. 4 is a diagram illustrating an example of a directory structure and a physical server connection.

A directory structure 70 indicates an example of a directory structure including directories D10, D11, and D12 and files F11 and F12.

The directory D10 is a root directory.

The directory D11 is a directory directly under the directory D10.

The directory D12 is a directory directly under the directory D10.

The file F11 is a file directly under the directory D11.

The file F12 is a file directly under the directory D11.

A physical server connection 80 indicates an example of a physical server connection configuration of the MDSs 100, 100a, 100b, 100c, . . . and a switch 61. The switch 61 is an infiniband switch belonging to the network 60.

For example, each of the MDSs 100, 100a, 100b, 100c, . . . is connected to the switch 61 by a cable.

For example, metadata in the directory D10 is managed by the MDS 100. The metadata in the directory D10 is stored in the MDT 300.

Metadata in the directory D11 is managed by the MDS 100c. The metadata in the directory D11 is stored in an MDT connected to the MDS 100c.

Metadata in the directory D12 is managed by the MDS 100b. The metadata in the directory D12 is stored in the MDT 300b.

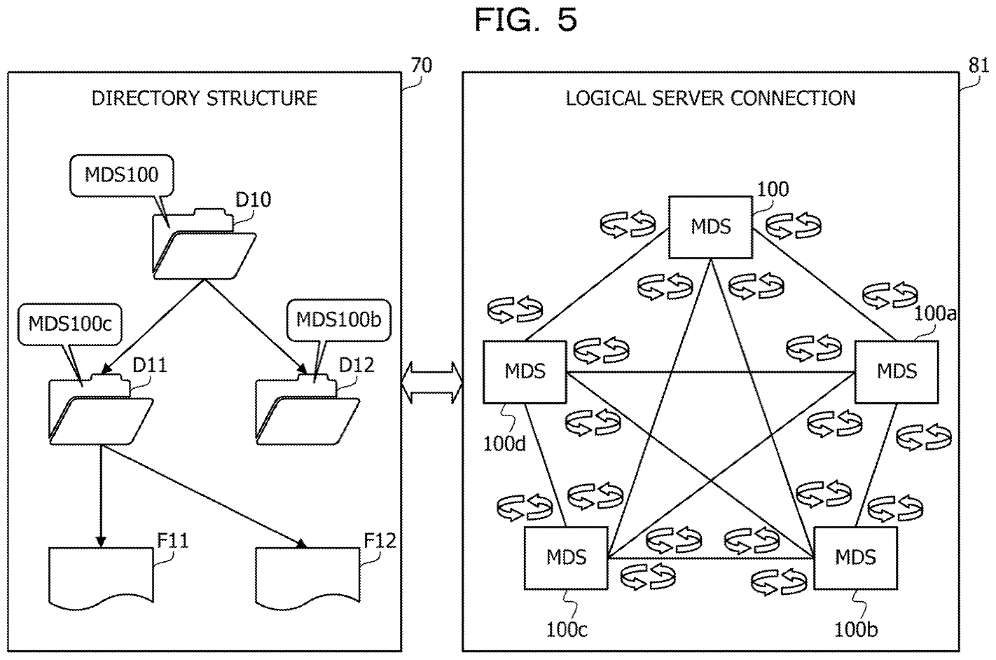

FIG. 5 is a diagram illustrating an example of a directory structure and a logical server connection.

For example, the MDSs 100, 100a, 100b, 100c, and 100d mutually establish a connection based on an RDMA protocol in infiniband, and communicate using the connection. When a connection has been established, it is possible to read/write directly from/to a RAM of an MDS at the other end of the connection by RDMA Read/Write. Using the connection allows for communication at a speed higher than that of communication without using a connection, for example, connectionless communication. One connection is established for each pair of a data transmission source and a data transmission destination.

A logical server connection 81 indicates an example of a logical server connection configuration corresponding to the directory structure 70 and the physical server connection 80, for example, an example of a connection established between MDSs. However, in the logical server connection 81, the MDSs 100, 100a, 100b, 100c, and 100d are exemplified, and other MDSs are not illustrated. Furthermore, between two MDSs, there may be a connection for transmitting data from a first MDS to a second MDS and a connection for transmitting data from the second MDS to the first MDS. FIG. 5 illustrates just one association line between two MDSs.

For example, in a case where one MDS establishes connections with all the other MDSs, and the number of MDSs is N (N is an integer equal to or greater than 2), then N×(N−1) connections exist. In an example of N=5, the number of connections for all pairs of MDSs is 5×4=20.

However, maintaining connections consumes resources. For example, a data transmission source MDS and a data transmission destination MDS consume storage areas in RAMs to provide a transmission buffer and a reception buffer, respectively, for the corresponding connection. Furthermore, for example, the data transmission destination MDS uses a CPU resource to periodically poll whether data received from the data transmission source MDS exists in the reception buffer corresponding to the corresponding connection.

On the other hand, physical resources of each MDS are limited. For this reason, it is difficult for each MDS to permanently maintain all established connections.

Note that for communication between MDSs, connectionless communication may also be performed as described above. In connectionless communication, a dedicated resource is not secured for the communication. Connectionless communication is performed by, for example, message-based processing by send/recv. In connectionless communication, both a data transmission source MDS and a data transmission destination MDS use storage areas in RAMs that are not dedicated to communication, for example, storage areas in RAMs that may be used also by software other than communication software. Thus, connectionless communication is slower than communication using a connection because extra processing such as memory copy occurs in the MDSs.

Each MDS maintains connections of high importance and terminates connections of low importance among connections that have been established between the MDS and data transmission destination MDSs, thereby providing a resource-saving function. For data transmission destination MDSs that have been disconnected, connectionless communication may be used. In determining the importance of a connection, each MDS uses a method specific to distributed file systems, as exemplified below.

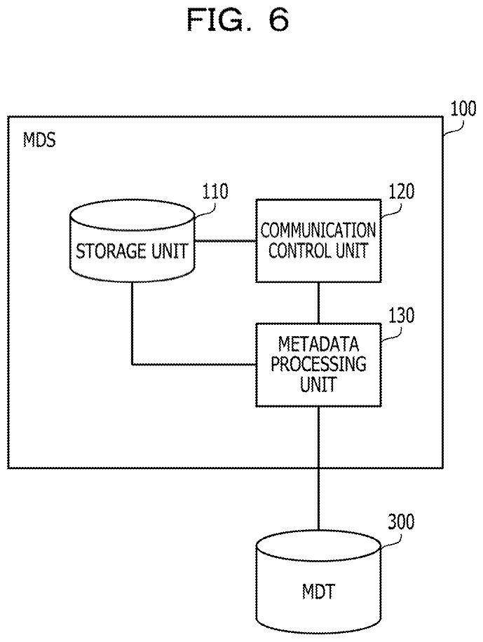

FIG. 6 is a diagram illustrating an example of functions of an MDS.

The MDS 100 includes a storage unit 110, a communication control unit 120, and a metadata processing unit 130. A storage area of the RAM 102 or the HDD 103 is used as the storage unit 110. The communication control unit 120 and the metadata processing unit 130 are implemented by the CPU 101 executing a program stored in the RAM 102.

The storage unit 110 stores a connection management table and a weighted communication count table.

The connection management table is a table for managing an established connection between the MDS (for example, the MDS 100) and a data transmission destination MDS. It may be said that connections registered in the connection management table are connections that are currently being maintained, and resources are consumed for the connections.

The weighted communication count table is a table for managing the number of weighted communications in communication between the MDS 100 and a data transmission destination MDS. The number of weighted communications indicates the importance of communication between the MDS 100 and the data transmission destination MDS, for example, the priority in terms of being maintained. The higher the number of weighted communications, the higher the importance and the higher the priority in terms of being maintained. The smaller the number of weighted communications, the lower the importance and the lower the priority in terms of being maintained. A low priority in terms of being maintained indicates a high priority in terms of being terminated.

Here, the number of weighted communications is obtained by weighting and accumulating the number of communications between the MDS 100 and the data transmission destination MDS. The number of weighted communications is counted for directory access communications from the MDS 100 to the data transmission destination MDS. For example, a directory access occurs when the MDS 100 queries the data transmission destination MDS for information regarding other directories subordinate to a directory managed by the MDS 100.

The weight applied to the number of communications is set so that the higher the level of the directory to be accessed, the higher the weight. As the weighting method, the following first weighting method or second weighting method is used.

In the first weighting method, the sum of the numbers of accesses to the entries existing under the corresponding directory is used as a weight of the directory. The entries are files and directories. Furthermore, the “entries existing under the corresponding directory” include the corresponding directory, and are all the entries obtained by moving along edges in the tree structure downward from the directory to the lowest layer.

In the second weighting method, the number of entries (which may include the corresponding directory) existing subordinate to the corresponding directory is used as a weight of the directory. The number of entries is the sum of the number of files and the number of directories. The “entries existing subordinate to the corresponding directory” are all the entries obtained by moving along edges in the tree structure downward from the corresponding directory to the lowest layer. An edge indicates a parent-child relationship between a directory and a subdirectory, or a directory and a file. Note that the entries existing subordinate to the corresponding directory may include the corresponding directory itself. In this case, the “entries existing subordinate to the corresponding directory” has the same meaning as the “entries existing under the corresponding directory”.

The communication control unit 120 communicates with another MDS in accordance with metadata processing by the metadata processing unit 130. The communication control unit 120 may establish a connection with the other MDS. The communication control unit 120 registers a record of the established connection in the connection management table. The communication control unit 120 maintains the connection established with the other MDS, and uses the connection to transmit data to the other MDS.

Furthermore, the communication control unit 120 may terminate an established connection. The communication control unit 120 deletes the record of the terminated connection from the connection management table. The communication control unit 120 counts the number of weighted communications of communication with a data transmission destination MDS, and records the count in the weighted communication count table.

The communication control unit 120 selects the first weighting method or the second weighting method in accordance with the trend of accesses to directories and files in the information processing system 2. The communication control unit 120 uses the first weighting method in a case where the entries are not uniformly accessed, and uses the second weighting method in a case where the entries are uniformly accessed. The distribution in the number of accesses for each directory level may be used to determine whether accesses to each entry occur uniformly. For example, in a case where an average value of all levels regarding the distribution in the number of accesses for each directory level is smaller than a threshold value, accesses to each entry occur uniformly. In a case where the average value is equal to or greater than the threshold value, it is determined that accesses to each entry do not occur uniformly. Note that the communication control unit 120 may use a standard deviation instead of the distribution.

The metadata processing unit 130 performs metadata processing. The metadata processing is a predetermined processing based on metadata stored in the MDT 300. The metadata processing may occur when a directory access or a file access from the client 500 or 500a has been received. For example, the metadata processing unit 130 may provide the client 500 or 500a with a storage destination address of a data body included in the metadata.

Furthermore, the metadata processing unit 130 may perform a directory access to a subdirectory of a directory (a directory subordinate to the corresponding directory) accessed from the client 500 or 500a. A directory access involves making a metadata query to an MDS that manages metadata in the corresponding directory. For example, the metadata processing unit 130 may confirm existence of the subdirectory with another MDS or acquire detailed information of the subdirectory from the other MDS, and then provide the result to the client 500 or 500a.

Moreover, when the metadata processing unit 130 has received an access to a certain directory or file from the client 500 or 500a, the metadata processing unit 130 may confirm an access authority for the directory or file, or may confirm an access authority for a higher-level directory. In this case, the metadata processing unit 130 may perform a directory access to a higher-level directory to confirm the access authority for the higher-level directory.

In a similar manner to the client 500 or 500a, the metadata processing unit 130 identifies an access destination MDS on the basis of a hash of a full path of an access destination directory or file. For example, the storage unit 110 stores in advance information indicating a correspondence relationship between a hash and an address of an MDS associated with the hash. Communication with another MDS for a directory access is executed by the communication control unit 120.

Note that the MDSs 100a, 100b, . . . have functions similar to those of the MDS 100.

Next, an example of a data structure of the information processing system 2 will be described. First, an example of metadata will be described.

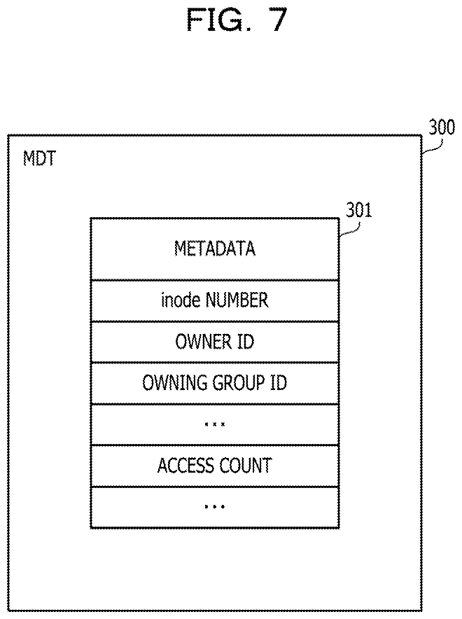

FIG. 7 is a diagram illustrating an example of metadata.

Metadata 301 is stored in the MDT 300. The metadata 301 exists for each directory or file managed by the MDS 100. The metadata 301 includes “Inode number”, “Owner ID”, “Owning group ID”, and “Access count” fields.

The “Inode number” field is where an inode number is registered. The “Owner ID” field is where a user ID of an owner of the corresponding directory or file is registered. The “Owning group ID” field is where a group ID of a group to which the owner of the corresponding directory or file belongs is registered. The “Access count” field is where the number of accesses to the corresponding directory or file is registered. The “Access count” is incremented by 1 each time an access to the corresponding directory or file is received.

The metadata 301 may include fields other than the fields described above, but such fields are not illustrated in FIG. 7. For example, in a case where the entry corresponding to the metadata 301 is a directory, the metadata 301 may include directory structure information such as a name and an inode number of a directory or a file that exists directly under the directory.

However, as described above, the directory structure information may be stored in any of the OSTs 400, 400a, . . . as a data body of the directory. In that case, the MDS 100 may acquire the data body of the corresponding directory from the OSSs 200, 200a, . . . to acquire the directory structure information.

Note that the MDTs 300a, 300b, . . . also have metadata similar to that of the MDT 300.

Next, an example of a data structure retained by the MDS 100 will be described.

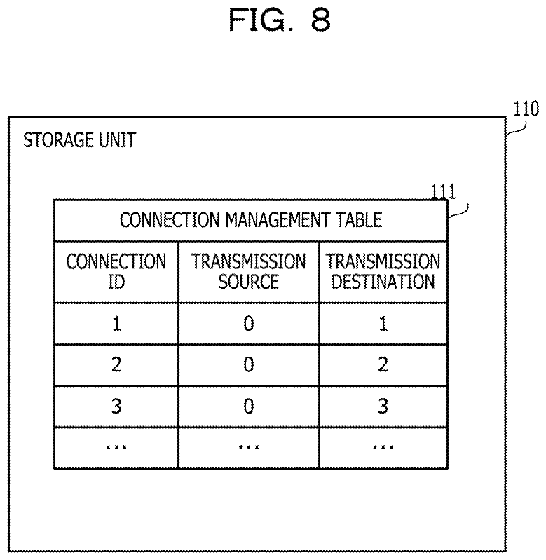

FIG. 8 is a diagram illustrating an example of a connection management table.

A connection management table 111 is stored in the storage unit 110. The connection management table 111 includes “Connection ID”, “Transmission source”, and “Transmission destination” items.

The “Connection ID” item is where a connection ID, which is identification information of a connection, is registered. The “Transmission source” item is where a hash of the MDS 100 is registered. The “Transmission destination” item is where a hash of a data transmission destination MDS is registered. The hash indicating the MDS 100 is “0”.

For example, the following record is registered in the connection management table 111: Connection ID “1”, Transmission source “0”, and Transmission destination “1”. This record indicates that there is an established connection with Connection ID “1” from the MDS 100 to an MDS identified by the hash “1”.

In the connection management table 111, records of established connections are registered also tor other data transmission destination MDSs.

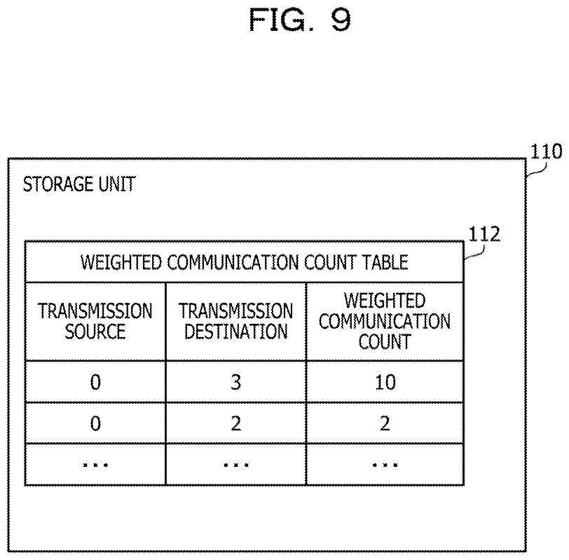

FIG. 9 is a diagram illustrating an example of a weighted communication count table.

A weighted communication count table 112 is stored in the storage unit 110. The weighted communication count table 112 includes “Transmission source”, “Transmission destination” and “Weighted communication count” items.

The “Transmission source” item is where a hash of the MDS 100 is registered. The “Transmission destination” item is where a hash of a data transmission destination MDS is registered.

For example, the following record is registered in the weighted communication count table 112: Transmission source “0”, Transmission destination “3”, and Weighted communication count “10”. This record indicates that the number of weighted communications from the MDS 100 to an MDS identified by the hash “3” is “10”.

In the weighted communication count table 112, the number of weighted communications is also registered for other data transmission destination MDSs. The number of weighted communications is recorded for each data transmission destination MDS regardless of whether there is a connection.

The weighted communication count table 112 is an example of the priority information 23 according to the first embodiment.

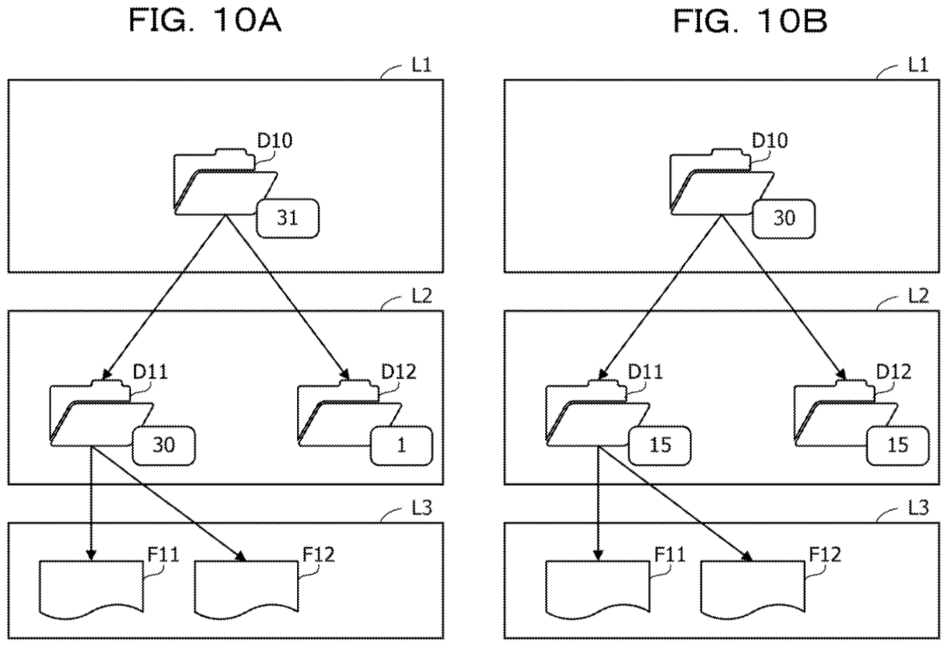

FIGS. 10A and 10B are diagrams illustrating examples of the trend of access.

FIG. 10A illustrates an example in which accesses to the directories D10, D11, and D12 are biased. FIG. 10B illustrates an example in which accesses to the directories D10, D11, and D12 are unbiased.

Here, the directory D10 is a root directory, and belongs to a directory level L1. The directories D11 and D12 are directories directly under the directory D10, and belong to a directory level L2. The files F11 and F12 are files directly under the directory D11, and belong to a directory level L3.

In this case, the directory level L1 is higher than the directory level L2. The directory level L2 is higher than the directory level L3.

Here, the description is focused on the numbers of accesses to the directories D11 and D12 in the directory level L2. The numbers of accesses to the directories D11 and D12 are respectively recorded in metadata of the directory D11 and metadata of the directory D12.

In the first weighting method described above, a weight of a certain directory, for example, a weight of communication to the directory is the total number of accesses to the directory and all entries subordinate to the directory. For example, the weight of communication from the MDS 100 that manages the directory D10 to the MDS 100c that manages the directory D11 is the sum of the number of accesses to the directory D11, the number of accesses to the file F11, and the number of accesses to the file F12. The total number of accesses is referred to as a cumulative number of accesses.

In the example in FIG. 10A, the cumulative number of accesses for the directory D11 is “30”. The cumulative number of accesses for the directory D12 is “1”. In this case, the cumulative number of accesses for the directory D11 is “30”, and the cumulative number of accesses for the directory D12 is “1”. The two numbers differ widely from each other. The sum of the cumulative numbers of accesses for the directories D11 and D12 is “31”. Thus, the influence of the directories D11 and D12 on the cumulative number of accesses for the directory D10 is “31”.

In the example in FIG. 10B, the cumulative number of accesses for the directory D11 is “15”. The cumulative number of accesses for the directory D12 is “15”. In this case, the cumulative numbers of accesses for the directories D11 and D12 are uniform. Furthermore, the sum of the cumulative numbers of accesses for the directories D11 and D12 is “30”. Thus, the influence of the directories D11 and D12 on the cumulative number of accesses for the directory D10 is “30”.

The communication control unit 120 obtains, for each directory level, a distribution of the cumulative number of accesses for each directory included in the directory level. For example, a distribution of the cumulative number of accesses to each directory in the directory level L1, a distribution of the cumulative number of accesses to each directory in the directory level L2, and a distribution of the cumulative number of accesses to each directory in the directory level L3 are obtained.

The communication control unit 120 determines whether the directories are uniformly accessed by comparing a threshold value and an average value of all directory levels regarding the distribution obtained for each directory level. For example, the average value of the distributions is an average value of the three distributions obtained for the directory levels L1, L2, and L3. In a case where the average value of the distributions is smaller than the threshold value, the directories are uniformly accessed. In a case where the average value of the distributions is equal to or greater than the threshold value, the directories are not uniformly accessed. The threshold value is recorded in advance in the storage unit 110.

Next, a procedure of processing by the MDS 100 will be described. The following description mainly exemplifies the MDS 100, and the MDSs 100a, 100b, . . . execute a similar procedure.

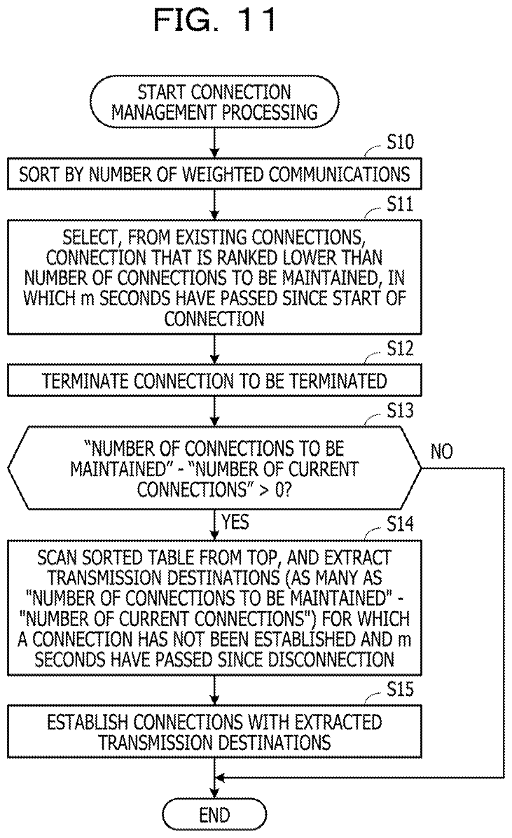

FIG. 11 is a flowchart illustrating an example of connection management processing.

The MDS 100 periodically executes the following procedure.

(S10) The communication control unit 120 sorts the records in the weighted communication count table 112 in descending order of the number of weighted communications. As a result, the records in the weighted communication count table 112 are arranged in order from the largest number of weighted communications to the smallest. In this case, a record closer to the beginning of the sort result is ranked higher, and a record closer the end of the sort result is ranked lower. The ranking is indicated by a ranking number. The smaller the ranking number, the higher the ranking. The higher the ranking number, the lower the ranking.

(S11) From the existing connections, the communication control unit 120 selects, as a connection to be terminated, a connection that is ranked lower than the number of connections to be maintained in the weighted communication count table 112 after the sorting in step S10, in which m seconds have passed since the start of the connection. Being ranked lower than the number of connections to be maintained means that the ranking number is higher than the number of connections to be maintained. The existing connections are identified from the connection management table 111. The number of connections to be maintained indicates an upper limit of the number of connections to be maintained, and is set in advance in the storage unit 110.

(S12) The communication control unit 120 terminates the connection selected in step S11 as a connection to be terminated. The communication control unit 120 deletes the record corresponding to the terminated connection from the connection management table 111. The resource secured for the terminated connection is released.

(S13) The communication control unit 120 determines whether “the number of connections to be maintained”−“the number of current connections”>0 holds. The number of current connections corresponds to the number of records registered in the connection management table 111. If “the number of connections to be maintained”−“the number of current connections”>0 holds, the communication control unit 120 proceeds the processing to step S14. If “the number of connections to be maintained”−“the number of current connections”≤0 holds, the communication control unit 120 ends the connection management processing. If “the number of connections to be maintained”−“the number of current connections”>0 holds, there is a surplus in the number of connections that may be maintained.

(S14) The communication control unit 120 scans the weighted communication count table 112 after the sorting in step S10 in order from the top, and extracts transmission destinations for which a connection has not been established and m seconds have passed since disconnection, the number of the extracted transmission destinations being equal to (the number of connections to be maintained−the number of current connections).

(S15) The communication control unit 120 establishes connections with MDSs corresponding to the extracted transmission destinations. The communication control unit 120 adds records of the established connections to the connection management table 111. Then, the communication control unit 120 ends the connection management processing.

In this way, on the basis of the weighted communication count table 112, the communication control unit 120 maintains connections, with the connections kept established, in order from the connection with the largest number of weighted communications up to a specified number. However, since a cost for establishing and terminating connections is high, the communication control unit 120 stores a connection management list regarding connections in the storage unit 110, and uses the connection management list to keep connections that have been established during the last m seconds from being terminated. Furthermore, the communication control unit 120 performs a control so that a connection to the same transmission destination is not established for m seconds after disconnection. In the connection management list, connection IDs of connections that have been established during the last m seconds and connection IDs of connections in which m seconds have not passed since disconnection are recorded. Note that m is set in advance in the storage unit 110 as a value at which communication and processing costs for connection and disconnection do not exceed benefits of high-speed connection using a connection.

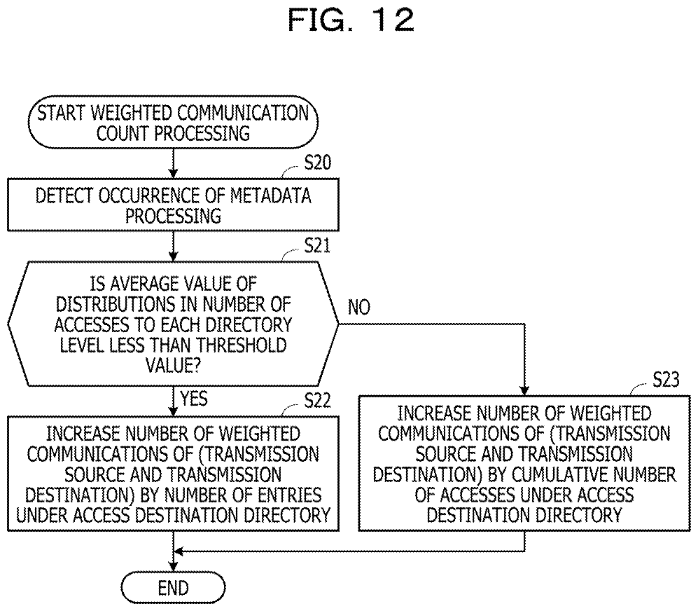

FIG. 12 is a flowchart illustrating an example of weighted communication count processing.

(S20) The communication control unit 120 detects an occurrence of metadata processing by the metadata processing unit 130.

(S21) The communication control unit 120 determines whether an average value of distributions in the number of accesses to each directory level is less than a threshold value. If the average value of the distributions is less than the threshold value, the communication control unit 120 proceeds the processing to step S22. If the average value of the distributions is equal to or greater than the threshold value, the communication control unit 120 proceeds the processing to step S23. As described above, the distribution of the number of accesses for each directory level is obtained for the cumulative number of accesses to a plurality of directories belonging to the corresponding directory level.

(S22) The communication control unit 120 increases the number of weighted communications of (transmission source and transmission destination) in the weighted communication count table 112 by the number of entries under an access destination directory. Here, the transmission source is the MDS 100. The transmission destination is a directory access destination MDS that has occurred in association with the metadata processing by the metadata processing unit 130. The number of entries under the access destination directory may be recorded in, for example, metadata of the access destination directory, or may be recorded in an OST as a data body of the directory. The communication control unit 120 may acquire the number of entries under the access destination directory from an MDS that manages the access destination directory or an OSS that manages the data body of the directory. Then, the communication control unit 120 ends the weighted communication count processing.

(S23) The communication control unit 120 increases the number of weighted communications of (transmission source and transmission destination) in the weighted communication count table 112 by the cumulative number of accesses under the access destination directory. The cumulative number of accesses under the access destination directory is obtained as the sum of the numbers of accesses for metadata in the entries under the access destination directory. For this reason, the communication control unit 120 acquires information regarding the number of accesses from the access destination MDS in association with a directory access. Furthermore, in a case where the access destination directory has a further lower directory level, information regarding the number of accesses for entries existing in the lower directory level is acquired repeatedly up to the lowest directory level. Then, the communication control unit 120 ends the weighted communication count processing.

Note that, as described above, the weighted communication count is recorded for each data transmission destination MDS regardless of whether there is a connection. Furthermore, the communication control unit 120 periodically updates the average value of distributions used for the determination in step S21, and selects a weighting method suitable for the current trend of access. For example, instead of obtaining an average value of distributions used for the determination in step S21 each time the procedure illustrated in FIG. 12 is executed once, the communication control unit 120 may obtain the average value of the distributions each time the procedure illustrated in FIG. 12 is executed a plurality of times.

Here, in the first weighting method (step S23), in a case where there is an entry at a level lower than the access destination directory, the number of accesses to the lower entry is repeatedly acquired to obtain the cumulative number of accesses. For this reason, in a case where the access is uniform, a weight may be more easily assigned to the directory by using the second weighting method (step S22) than by using the first weighting method, and the load on the MDS 100 may be reduced.

In this way, the communication control unit 120 may select connections to be terminated on the basis of the weighted communication count table 112, thereby performing a control so as to maintain connections used for high-priority communication and terminate connections used for low-priority communication. Furthermore, in a case where there are available resources due to termination of a connection, it is possible to establish a new connection to a transmission destination MDS, for which a connection has not been established, whose priority has increased at the timing after the termination, and communicate with the transmission destination MDS at a high speed.

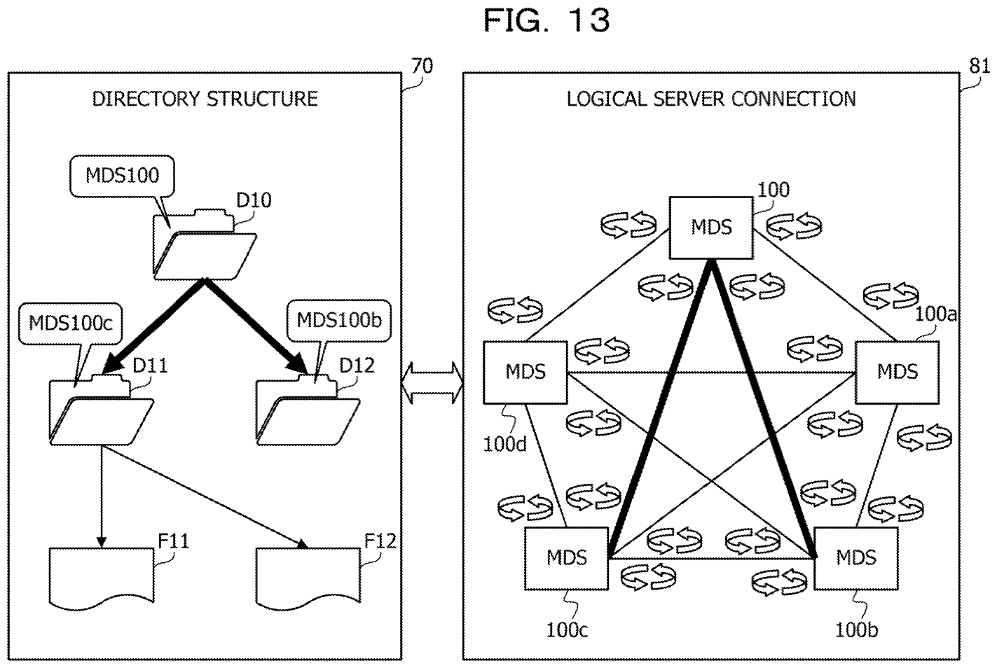

FIG. 13 is a diagram illustrating an example of connections to be maintained.

The higher the directory is in the directory structure 70, the more entries there are subordinate to it, and it is considered that there is a high possibility that an access is likely to occur in association with an access to a subordinate entry or the like. For this reason, by using the first weighting method or the second weighting method described above, the MDS 100 controls so that the higher the directory is in the directory structure 70, the larger the weight tends to be.

In the example of the directory structure 70, the directory D10 is a root directory, and the directories D11 and D12 exist directly under the directory D10. For example, from the MDS 100, the connection to the MDS 100c that manages the metadata in the directory D11 and the connection to the MDS 100b that manages the metadata of the directory D12 tend to be maintained as compared with the connections to the MDS 100a and 100d.

Meanwhile, the amount of metadata that stores file information of a large-capacity file system has been currently increased, and the information processing system 2 is used for management and processing in a distributed manner.

In a case where there are a large number of MDSs, establishing software-based connections among all the MDSs results in a huge number of connections and an increase in the amount of resources consumed by the MDSs.

For this reason, making use of the fact that metadata is in a tree shape due to the parent-child relationship in a directory structure, the MDSs 100, 100a, . . . reduce the number of connections by preferentially maintaining connections often used for communication.

As a result, the number of connections to be maintained may be reduced while suppressing deterioration in performance such as throughput and latency, and the memory usage and CPU load in an MDS may be efficiently reduced. At this time, making use of handling a tree-like data structure, each MDS makes the weight variable in accordance with the nature of the directory tree (the number of accesses to lower entries and the number of entries), not the number of communications by the corresponding connection. For this reason, for example, for communications related to higher levels in a directory tree, the weight of the count of the number of communications may be increased.

In this way, each MDS may maintain connections that are estimated to be likely to be used tor a large number of communications in the future, and terminate appropriate connections.

To summarize the above, the information processing system 2 has the following functions.

The information processing system 2 includes the MDSs 100, 100a, 100b, . . . that manage information in a plurality of directories in a distributed manner. The following description exemplifies the MDS 100, and the MDSs 100a, 100b, . . . have functions similar to those of the MDS 100.

The MDS 100 assigns a weight to each directory managed by a communication destination MDS on the basis of a tree structure including a plurality of directories. On the basis of an occurrence of a communication for the directory, the MDS 100 uses the weight of the directory to determine the priority of the connection used for communication with the communication destination MDS. The MDS 100 terminates at least one connection on the basis of the priority of each of the plurality of connections to a plurality of communication destination MDSs.

As a result, an appropriate connection may be terminated.

Here, the number of weighted communications in the weighted communication count table 112 is an example of the priority of a connection. A total number of accesses to entries under a directory and a total number of the entries under the directory are examples of the weight of the directory.

The MDS 100 assigns a weight to each directory so that the higher the directory is in the tree structure of the directory tree, the larger the weight.

As a result it is possible to increase the weight of the count of the number of communications for communications related to higher levels in a directory tree and maintain connections that are estimated to be likely to be used for a large number of communications in the future.

For example, the MDS 100 uses, as a weight of a certain directory, a cumulative number of accesses to each of the directory, files that exist subordinate to the directory, and other directories that exist subordinate to the directory.

As a result the weight of the count of the number of communications may be appropriately increased for communications related to higher levels in a directory tree.

Furthermore, for each of a plurality of levels in the tree structure of the directory tree, the MDS 100 calculates a distribution or standard deviation of the cumulative number described above for each directory that belongs to the level, and calculates an average value of a plurality of distributions or a plurality of standard deviations calculated for the plurality of levels. Then, in a case where the average value is smaller than a threshold value, the MDS 100 uses, a weight of the directory, a total number of files that exist subordinate to the directory and other directories that exist subordinate to the directory, instead of the cumulative number of accesses described above.

As a result, in a case where there is a trend that there is less variation in accesses to each directory, the priority of each connection may be easily determined, and the load on each MDS may be suppressed.

Each time a communication for the corresponding directory occurs, the MDS 100 accumulates the weight of the directory for a connection used for the communication, and uses the accumulated weight as the priority of the connection.

As a result, the priority of the connection frequently used for communication may be appropriately increased in accordance with the weight of the access destination directory.

Furthermore, by using weights assigned one to each of other directories managed by other communication destination MDSs for which a connection has not been established, the MDS 100 determines the priority of connectionless-type communications (sometimes referred to as connectionless communications) with other communication destination MDSs based on an occurrence of communication for the other directories. Then, when the MDS 100 terminates at least one connection, the MDS 100 establishes, on the basis of the determined priority, a connection with another communication destination MDS for which a connection has not been established.

This allows for communication using a connection through a communication path of connectionless communication that is currently being used more frequently, and high-speed communication through the communication path.

The MDS 100 identifies a predetermined number of connections and connectionless communications from the highest in the priority among those for which the priority has been determined, and terminates connections that have not been identified. The MDS 100 establishes connections with other communication destination MDSs corresponding to the identified connectionless communications.

As a result, it is possible to appropriately terminate a connection having a lower priority than connectionless communication in accordance with the current communication status. Furthermore, instead of the terminated connection, a connection is established for the communication path of the connectionless communication whose priority has increased, and the connection allows for communication at a high speed.

The MDS 100 excludes, from connections to be terminated, a connection in which a first period has not passed since the connection has been established. The MDS 100 excludes, from MDSs for which new connections are to be established, a communication destination MDS corresponding to a connection in which a second period has not passed since the connection has been terminated.

As a result, it is possible to suppress a phenomenon in which establishment and termination of connections frequently occur in a short period of time for the same MDS at the other end of communication, and it is possible to suppress an increase in load on the MDS and the MDS at the other end of communication caused by the phenomenon. The first period and the second period may have the same length, or may have different lengths. The “m seconds” in steps S11 and S14 is an example of the length of the first period and the second period.

Note that the information processing according to the first embodiment may be implemented by causing the processing unit 13 to execute the program. Furthermore, the information processing according to the second embodiment may be implemented by causing the CPU 101 to execute the program. The program may be recorded in the computer-readable recording medium 53.

For example, the program may be distributed by distributing the recording medium 53 in which the program is recorded. Alternatively, the program may be stored in another computer and distributed via a network. For example, a computer may store (install) the program, which is recorded in the recording medium 53 or received from another computer, in a storage device such as the RAM 102 or the HDD 103, read the program from the storage device, and execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising
a plurality of information processing devices configured to manage information in a plurality of directories in a distributed manner,
wherein a first information processing device that is any one of the plurality of information processing devices is configured to perform processing, the processing including:
managing, for a respective communication destination information processing device for the first information processing, a connection established with the respective communication device, the respective communication destination information processing device being any one of the plurality of information processing devices other than the first information processing devices;
obtaining, in response to an occurrence of a communication targeting a directory managed by the respective communication destination information processing device, a weight corresponding to the directory targeted by the occurred communication, wherein each directory of the plurality of directories managed by the plurality of information processing devices is associated with a respective weight determined based on a tree structure of the plurality of directories;
determining, based on the obtained weight a priority of the connection used for the occurred communication, wherein each connection established with the respective communication destination information processing device is associated with a respective priority; and
selecting, on the basis of the determined priority, a connection from among each connection established with the plurality of information processing devices to terminate the selected connection.

2. The information processing system according to claim 1, wherein
the processing includes:
assigning the weight to each directory in such a way that the higher the directory is in the tree structure, the larger the weight.

3. The information processing system according to claim 2, wherein
the processing includes:
using, as the weight, a cumulative number of accesses to each directory or other objects subordinate to the each directory in the tree structure.

4. The information processing system according to claim 3, wherein
the processing includes:
calculating, for each level of the tree structure, a distribution or a standard deviation of the cumulative number for each directory that belongs to the level;
calculating an average value of a plurality of the distributions or a plurality of the standard deviations calculated for a plurality of the levels; and
using, in a case where the average value is smaller than a threshold value, instead of the cumulative number, a total number of files that exist subordinate to the directory and other directories that exist subordinate to the directory, as the weight.

5. The information processing system according to claim 1, wherein
the processing includes:
accumulating, each time the communication for the directory occurs, the weight of the directory for a connection used for the communication; and
using the accumulated weight as the priority of the connection.

6. The information processing system according to claim 1, wherein
the processing includes:
using the weight of each of other directories managed by other communication destination information processing devices, among the plurality of information processing devices, for which a connection has not been established, to determine the priority of connectionless communications with the other communication destination information processing devices based on the occurrence of the communication for the other directories; and
establishing, when the at least one connection is terminated, on the basis of the determined priority, connections with the other communication destination information processing devices for which a connection has not been established.

7. The information processing system according to claim 6, wherein
the processing includes:
identifying a predetermined number of connections and connectionless communications from the highest in the priority among connections and connectionless communications for which the priority has been determined, terminates connections that have not been identified; and
establishing connections with the other communication destination information processing devices corresponding to the identified connectionless communications.

8. The information processing system according to claim 6, wherein
the processing includes:
excluding, from connections to be terminated, a connection in which a first period has not passed since the connection has been established; and
excluding, from information processing devices for which new connections are to be established, the communication destination information processing device corresponding to a connection in which a second period has not passed since the connection has been terminated.

9. An information processing device operable as one of a plurality of information processing devices, the plurality of information processing devices being configured to manage information in a plurality of directories in a distributed manner, the information processing device comprising:
a memory; and
a processor coupled to the memory, the processor being configured to perform processing, the processing including:
managing, for a respective communication destination information processing device for the first information processing, a connection established with the respective communication device, the respective communication destination information processing device being any one of the plurality of information processing devices other than the first information processing devices;
obtaining, in response to an occurrence of a communication targeting a directory managed by the respective communication destination information processing device, a weight corresponding to the directory targeted by the occurred communication, wherein each directory of the plurality of directories managed by the plurality of information processing devices is associated with a respective weight determined based on a tree structure of the plurality of directories;
determining, based on the obtained weight, a priority of the connection used for the occurred communication, wherein each connection established with the respective communication destination information processing device is associated with a respective priority; and
selecting, on the basis of the determined priority, a connection from among each connection established with the plurality of information processing devices to terminate the selected connection.

10. The information processing device according to claim 9, wherein
the processing includes:
assigning the weight to each of the directories in such a way that the higher the directory is in the tree structure, the larger the weight.

11. The information processing device according to claim 10, wherein
the processing includes:
using, as the weight, a cumulative number of accesses to each directory or other objects subordinate to the each directory in the tree structure.

12. The information processing device according to claim 11, wherein
the processing includes:
calculating, for each level of the tree structure, a distribution or a standard deviation of the cumulative number for each directory that belongs to the level;
calculating an average value of a plurality of the distributions or a plurality of the standard deviations calculated for a plurality of the levels; and
using, in a case where the average value is smaller than a threshold value, instead of the cumulative number, a total number of files that exist subordinate to the directory and other directories that exist subordinate to the directory, as the weight.

13. The information processing device according to claim 9, wherein
the processing includes:
accumulating, each time the communication for the directory occurs, the weight of the directory for a connection used for the communication; and
using the accumulated weight as the priority of the connection.

14. A non-transitory computer-readable storage medium for storing a program which causes a computer to perform processing, the computer being operable as one of a plurality of information processing devices, the plurality of information processing devices being configured to manage information in a plurality of directories in a distributed manner, the processing comprising:
managing, for a respective communication destination device for the first information processing, a connection established with the respective communication device, the respective communication destination device being any one of the plurality of information processing devices other than the first information processing devices;
obtaining, in response to an occurrence of a communication targeting a directory managed by the respective communication destination device, a weight corresponding to the directory targeted by the occurred communication, wherein each directory of the plurality of directories managed by the plurality of information processing devices is associated with a respective weight determined based on a tree structure of the plurality of directories;
determining, based on the obtained weight, a priority of the connection used for the occurred communication, wherein each connection established with the respective communication destination device is associated with a respective priority; and
selecting, on the basis of the determined priority, a connection from among each connection established with the plurality of information processing devices to terminate the selected connection.

15. The non-transitory computer-readable storage medium according to claim 14, wherein
the processing includes:
assigning the weight to each directory in such a way that the higher the directory is in the tree structure, the larger the weight.

16. The non-transitory computer-readable storage medium according to claim 15, wherein
the processing includes:
using, as the weight, a cumulative number of accesses to each directory or other objects subordinate to the each directory in the tree structure.

17. The non-transitory computer-readable storage medium according to claim 16, wherein
the processing includes:
calculating, for each level of the tree structure, a distribution or a standard deviation of the cumulative number for each directory that belongs to the level;
calculating an average value of a plurality of the distributions or a plurality of the standard deviations calculated for a plurality of the levels; and
using, in a case where the average value is smaller than a threshold value, instead of the cumulative number, a total number of files that exist subordinate to the directory and other directories that exist subordinate to the directory, as the weight.

18. The non-transitory computer-readable storage medium according to claim 14, wherein
the processing includes:
accumulating, each time the communication for the directory occurs, the weight of the directory for a connection used for the communication; and
using the accumulated weight as the priority of the connection.

19. The non-transitory computer-readable storage medium according to claim 14, wherein
the processing includes:
using the weight of each of other directories managed by other communication destination information processing devices, among the plurality of information processing devices, for which a connection has not been established, to determine the priority of connectionless communications with the other communication destination information processing devices based on the occurrence of the communication for the other directories; and
establishing, when the at least one connection is terminated, on the basis of the determined priority, connections with the other communication destination information processing devices for which a connection has not been established.

20. The non-transitory computer-readable storage medium according to claim 19, wherein
the processing includes:
identifying a predetermined number of connections and connectionless communications from the highest in the priority among connections and connectionless communications for which the priority has been determined, terminates connections that have not been identified; and
establishing connections with the other communication destination information processing devices corresponding to the identified connectionless communications.
